(19) United States
(12) Patent Application Publication
(10) Pub. No.: US 2014/0008954 A1
(43) Pub. Date: Jan. 9, 2014

(54) DETACHABLE SEATING DEVICE

(71) Applicant: Ashok RAMTEKE, Pune (IN)

(72) Inventor: Ashok RAMTEKE, Pune (IN)

(73) Assignee: HEMA ENGINEERING INDUSTRIES LIMITED, Vimannagar (IN)

(21) Appl. No.: 13/613,924

(22) Filed: Sep. 13, 2012

(30) Foreign Application Priority Data
Jul. 4, 2012 (IN) 1932/MUM/2012

(51) Int. Cl. B60N 2/26; A47C 1/02

(52) U.S. Cl. 297/256.16

(57) ABSTRACT

The present invention relates to a detachable seating device comprising an arrangement in a seat base to hold a seat back, a mechanism to couple a seat base, the seat back and a seat back cover, a mechanism of reclining the seat back housed in the seat back cover, a mechanism for adjusting one or more reclining positions, one or more detachable side support pads and hand rests and a mechanism housed in the seat base for detaching and replacing at least one detachable side support pad with at least one hand rest.

### PREAMBLE TO THE DESCRIPTION

The following specification particularly describes the invention and the manner in Which it is to be performed:

### FIELD OF THE INVENTION

The present invention generally relates to a seating device and, more specifically, to a detachable seating device particularly designed for children.

### BACKGROUND OF THE INVENTION

Child seat development is continuously getting more challenging with introduction of new regulations. Addition of various features, to pass regulations, created designs with heavy structures and increase in weight. It becomes difficult to handle such seats during installations or operation.

The detachable seats are cited in U.S. Pat. No. 7,484,801B2, wherein a detachable safety seat comprises a base member, a seat body mounted on the base member detachably, an upper locking mechanism to lock or unlock a stand wall of the base member and a backrest of the seat body, a lower locking mechanism to lock or unlock a bottom wall of the base member and a seat of the seat body, and a synchronization mechanism to connect the upper locking mechanism to the lower locking mechanism so as to synchronize locked states or unlocked states of both locking mechanisms.

The attachment for child seat as cited in U.S. Pat. No. 6,764,135 B2, comprises the frame 6 having a seat side part 4, which faces a seat part 2a of a vehicle seat 2 and supports the backside of a seat part 3a of a child seat 3, and a back side part 5, which faces a back part 2b of the vehicle seat 2 and supports the backside of a back part 3b of the child seat 3; an first engagement part 8 made into engagement detachably with a second engagement part 7 provided on the back part 2b of the vehicle seat 2; and a fixing belt 9 fixing the child seat 3 to the frame 6.

The child seat as disclosed in document U.S. Pat. No. 6,375,260 B1, is formed of a child seat main portion for holding a child, and a base on which the child seat main portion is detachably mounted. The base has a connecting portion to be connected to a vehicle, and a fixing device engageable with an engaging member of the child seat main portion. An engagement-releasing member is installed in one of the base and the child seat main portion for releasing an engagement between the fixing device and the engaging member. In the child seat, a permission member is formed to cooperate with the connecting portion for allowing the child seat main portion to engage the base only when the base is connected to the vehicle. The child seat can be easily fixed to the vehicle.

In most of these inventions, the child seat base and back are integral. Moreover, the reclining of the child seat is accommodated in the seat base with the help of complicated mechanisms. These devices are bulky as well.

In light of the above, there is a need for a detachable child seat which has an easy mechanism of operation, has a light framework thereby overcoming the above listed drawbacks in the current system and providing a user-friendly device.

### SUMMARY OF THE INVENTION

An object of the present invention is to reduce the efforts for handling and installation. Subsequently, the injury sustained by child can be reduced by designing child seat with the idea of energy absorption and distribution structure provided in the present invention.

In various embodiments of the present invention, a seat back (1) is connected with a seat base (3), with the help of a D-shaped pin (7). A hinged joint is formed between the movable seat back and the fixed seat base (3) through the D-shaped pin (7).

In accordance with an embodiment of the present invention, the seat back (1) is reclined in this joint through the requisite angle of 8 degrees. D-shaped pin (7), which is held in the back cover, is supported by the slots provided in the seat back (1). During reclining, the long rod is pulled by the linkages, when two knobs are pushed. Thus this long rod is positioned in the different slot in the seat back (1). This takes the seat back in different positions. The seat base (3) is firmly fixed to the car seat through ISOFIX mechanism. The sides support for the child is detachable and can be replaced by handles as hand supports (4). The mechanism is devised for this application and housed in the child seat base (3).

In accordance with an embodiment of the present invention, the detachable seating device comprising an arrangement in the seat base (3) to hold the seat back (1), a mechanism to couple the seat base (3), the seat back (1) and the seat back cover, a mechanism of reclining the seat back (1) housed in the seat back cover, a mechanism for adjusting one or more reclining positions, one or more detachable side support pads and hand rests (4) and a mechanism housed in the seat base (3) for detaching and replacing at least one detachable side support pad (4) with at least one hand rest (4).

In accordance with an embodiment of the present invention, the arrangement in the seat base (3) is employed to hold the seat back (1), and comprises a D-shaped pin (7).

In accordance with an embodiment of the present invention, the mechanism to couple the seat base, the seat back (1) and the seat back cover involves a circular extension at bottom end of the seat back (1).

In accordance with an embodiment of the present invention, the circular extension at the bottom end of the seat back (1) is provided with a D-shaped hole and the D-shaped pin (7) rotates along with the seat back (1), the seat back cover remaining fixed with a seat base cover (2) acting as a bearing for the D-shaped pin (7).

In accordance with an embodiment of the present invention, the seat back (1) and the seat base (3) engaged together by a nut (71) and a pin are capable of being disengaged by removal of the nut and the pin.

In accordance with an embodiment of the present invention, the mechanism of reclining the seat back (1) and the seat back cover includes lifting at least one pin with at least two knobs on one or more sides.

In accordance with an embodiment of the present invention, wherein at least one pin supported by one or more springs (65) is under a spring force.

In accordance with an embodiment of the present invention, the mechanism of reclining the seat back (1) involves a plurality of links, which are fixed to an actuating rod (611) and at least one pin with one or more split pins (615, 614).

In accordance with an embodiment of the present invention, one or more knobs on one or more sides of the actuating rod (611) are involved in disengaging at least one pin (615, 614) from one or more slots for reclining.

In accordance with an embodiment of the present invention, one or more slots are provided in the seat back (1), an arrangement in the seat back cover engages with one or more slots (16) for adjusting in at least one reclining position.

In accordance with an embodiment of the present invention, the mechanism for adjusting one or more reclining positions includes rotating at least two knobs.

In accordance with an embodiment of the present invention, rotating at least two knobs allows rotation of the actuating rod (611) and with a plurality of connecting links it lifts at least one pin out of one or more slots in the seat back (1).

In accordance with an embodiment of the present invention, at least one pin is kept under pretention of one or more springs (65) being hooked to at least one pin and another end fixed to a projection in the seat back cover.

In accordance with an embodiment of the present invention, the mechanism for adjusting one or more reclining positions allows the seat back (1) to recline in one or more orientations.

In accordance with an embodiment of the present invention, one or more reclining positions depend upon the positioning of at least one pin in one or more slots.

In accordance with an embodiment of the present invention, the mechanism housed in the seat base for detaching and replacing at least one detachable side support pad with at least one hand rest (4) resides inside the seat base cover (2) with one or more screws (58).

In accordance with an embodiment of the present invention, the mechanism housed in the seat base for detaching and replacing at least one detachable side support pad with at least one hand rest (4) involves locking one or more on another rod locked with one or more slots in a slider (514).

In accordance with an embodiment of the present invention, the slider (514) is held by the spring force and one or more springs are placed on a screw between the slider (514) and a fixed end of a frame (51).

### BRIEF DESCRIPTION OF DRAWINGS

For a better understanding of the aforementioned embodiments of the invention as well as additional embodiments thereof, reference should be made to the Description of Embodiments below, in conjunction with the exemplary figures wherein:

FIG. 1 illustrates an exploded view of the child seat.

FIG. 1a depicts a back and back cover of the child seat in which EPS foam is fitted for the comfort of the child.

FIG. 2 shows the cover of the seat base. It encompasses the mechanism to detach side support/hand rest.

FIG. 3 illustrates the base of the child seat. This is used to hinge the seat back and back cover.

FIG. 4a illustrates the side support and is used to support the child from side.

FIG. 4b shows a hand rest used for resting the hand.

FIG. 5 shows the mechanism for detachment of side support/hand rest.

FIG. 6 illustrates the seat back cover fitted with the reclining arrangement.

FIG. 7 shows a D-shaped pin with nut

FIG. 8 shows a perspective view of different positions of seat back in reclining conditions.

### DESCRIPTION OF ELEMENTS REFERENCE NUMERALS

| | |
|---|---|
| actuating rod | 611 |
| Base cover | 2 |
| Child seat back | 1 |
| cavity | 37 |
| D-shaped pin | 7 |
| fix base/seat base | 3 |
| features | 27, 34, 35 & 39 |
| frame | 51 |
| groove | 613 |
| holes | 17, 21, 24, 25, 26, 28, 33, |
| | 36, 38, 52, 61, 62 & 66 |
| long pin | 64 |
| link | 67, 69 |
| nut | 59, 71 |
| operating knob | 70 |
| projections | 31, 32, 54, 63 & 612 |
| push knob | 512 |
| pins | 68 |
| round extension | 12 |
| round hollow projections | 29 |
| rectangular slots | 55 & 56 |
| split pin | 615 & 614 |
| Side Support, Hand Rest, types of attachments | 4 |
| screws | 58 |
| slots | 53, 57, 60 |
| snaps | 513 |
| slider | 514 |
| springs | 65 & 511 |

### DETAILED DESCRIPTION OF INVENTION

In the following detailed description, numerous specific details are set forth in order to provide a thorough understanding of some embodiments of the invention. However, it will be understood by persons skilled in the art that embodiments may be practiced without any specific details. In other instances, well-known methods, procedures, components and/or systems have not been described in detail so as not to obscure the discussion.

It will be appreciated that the embodiments of the invention hereinbefore described are given by way of example only, and are not meant to limit the scope of the invention in any way.

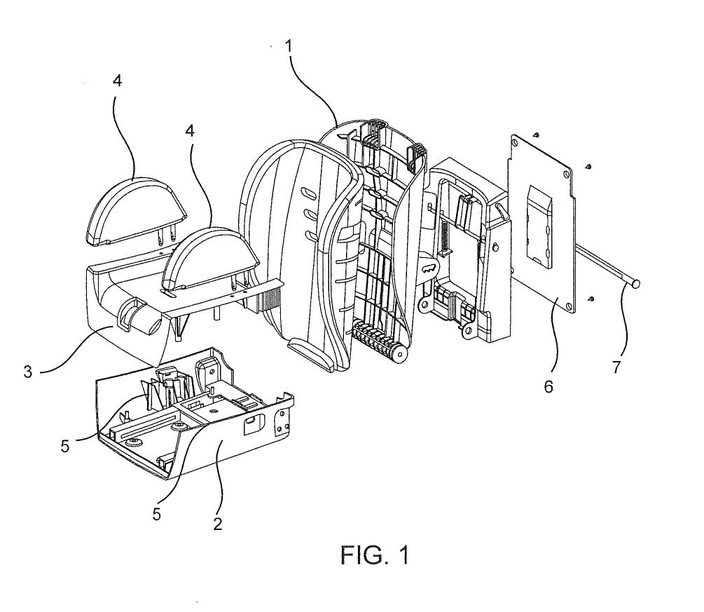

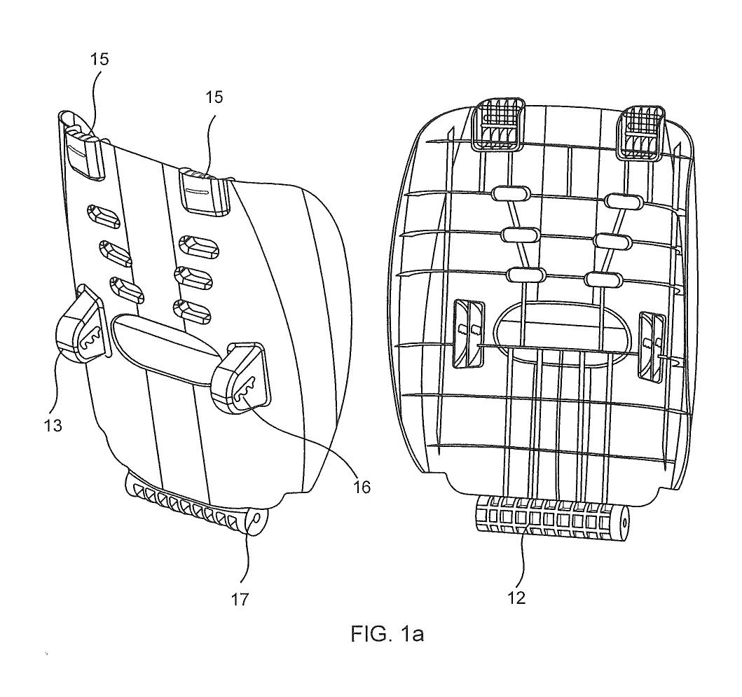

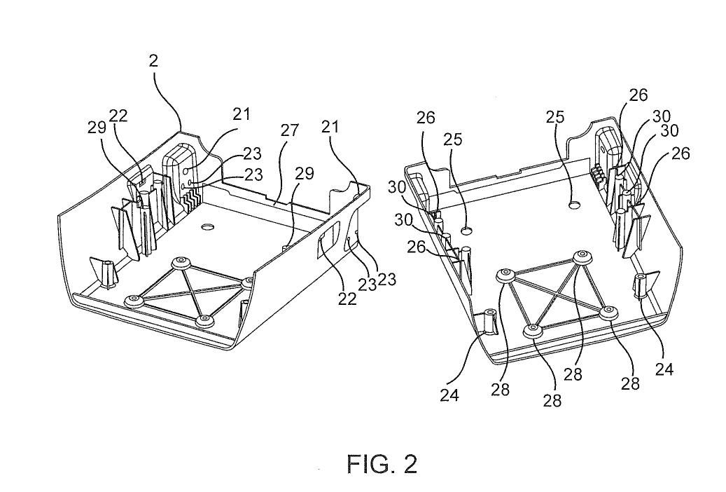

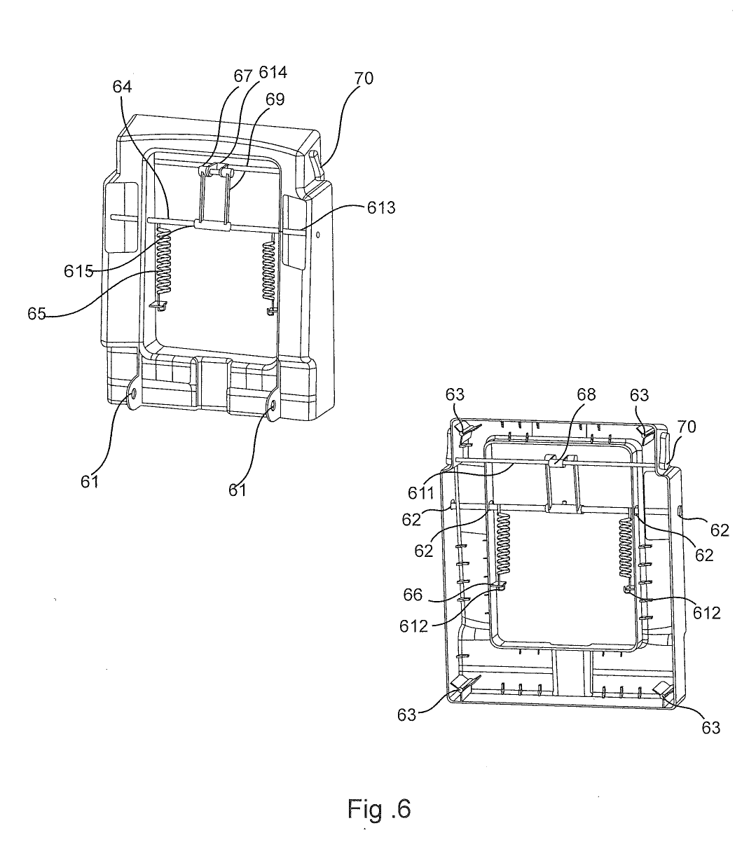

In an embodiment of the present invention, FIG. 1a depicts that a child seat back (1) is the main structure which absorbs major share of energy during the frontal or side impact. The back is connected to the base cover (2), FIG. 2, with the help of D-shaped pin (7), FIG. 1. This D-shaped pin is pushed through the hole (17) made in the round extension (12) of the child seat back (1). The rectangular flat face in the D-shaped pin is aligned with the matching rectangular face in the hole of round extension. This prevents the relative rotation of the seat back with the D-shaped pin and both move together. The D-shaped pin also passes through holes (61), FIG. 6, of the back cover and holes (21) of base cover.

In accordance with an embodiment of the present invention, FIG. 2 illustrates the base cover (2). D-shaped pin (7) is supported at both ends in the base cover holes. Supporting area of these holes acts as bearing to the D-shaped pin. The D-shaped pin is threaded at one end, which is tightened with the nut against the back cover. FIG. 2 is provided with the fixing arrangement for mechanism (5), FIG. 1, which is used to replace side support with hand rest. This mechanism is fitted with the help of screws in the holes (26). Holes (25) and holes (28) are used to fix ISOFIX mechanism structure to the base cover. Holes (24) are used to fix base (3) to the base cover (2). Round hollow projections (29) are used for guiding the seat base into the base cover. Feature (27) is provided to insert the ISOFIX mechanism fully inside the base cover when not in use.

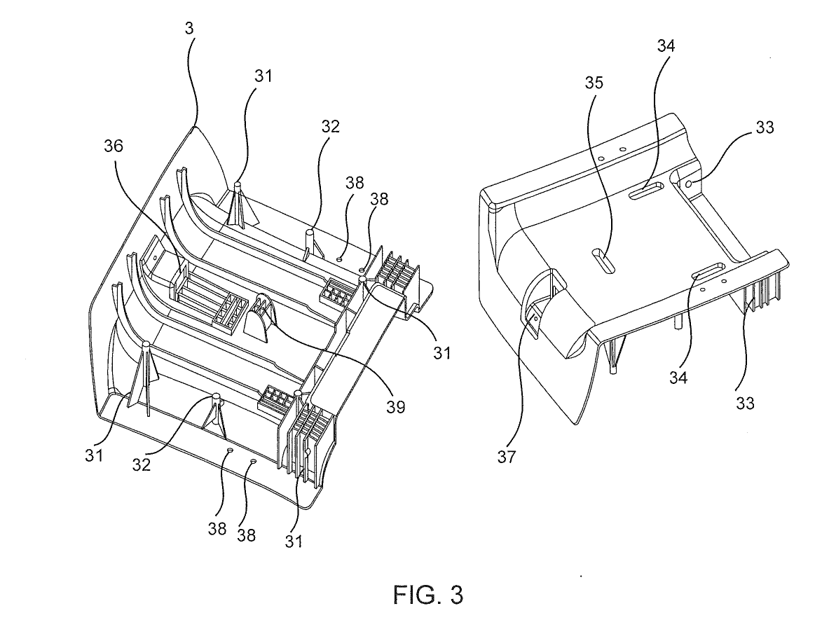

In accordance with an embodiment (FIG. 3) of the present invention, the base cover (2) is guided in the projections (32) and fixed to the base at projections (31) with the help of screws. The D-shaped pin (7), is guided through holes (33). Features (34) & (35) are used for tightly hooking the 5 point belt ends. The belt pretension device is fixed in the cavity (37) and the belt protruding through hole (36) is given pretension as per ECE R-44. Holes (38) are meant for holding the seat side support or hand rest to the base firmly. The feature (39) is provided for easy sliding and supporting the pretention belt.

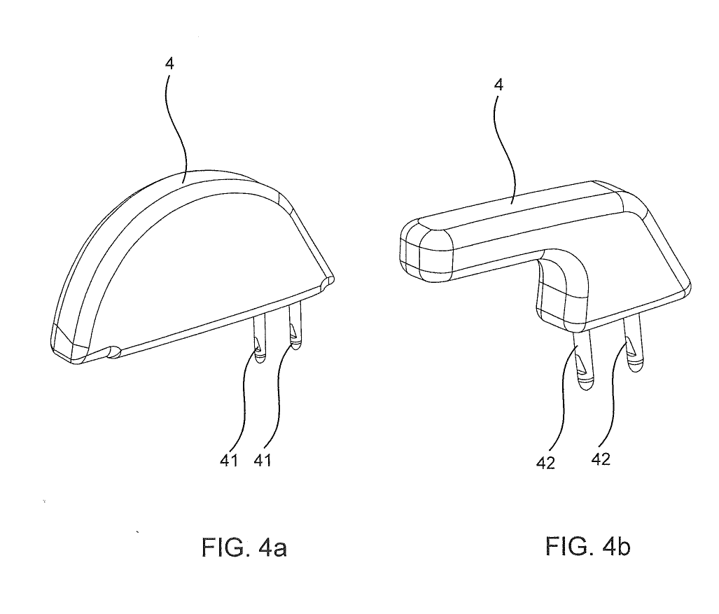

In accordance with an embodiment of the present invention, in FIG. 4a, Side Support & 4b, Hand Rest, types of attachments are shown (4). In FIG. 4a, the extension rod (41) has flat notch (42), which is used to hold child side support or hand rest firm in position during impact.

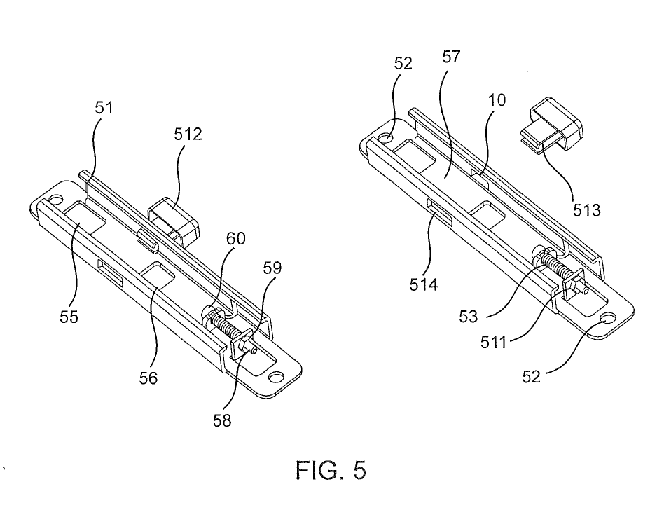

In accordance with an embodiment of the present invention, FIG. 5 shows the mechanism to hold child side support or hand rest in position. The frame (51) is fixed to the seat base through holes (52). The slots (53) are made to hook the push knob (512) at snaps (513) with the slot (57) in the slider (51a). The slider is kept in position with the help of spring (511). The spring is guided on the screw (58) held in the projection (54) with the help of nut (59). The head of the bolt is guided in the slot (60) of the slider. The notch in the extension rod, butt against the rectangular slots (55) & (56) under the spring load.

In accordance with an embodiment of the present invention, FIG. 6 shows the back cover with reclining mechanism fitted. This back cover is fitted, with two lips having through holes (61), to the seat back. The reclining mechanism is attached with the help of long pin (64). This long pin is supported in the back cover through holes (62). The long pin is always preloaded with springs (65). One end of this spring is held in the hole (66) of the projection (612). The other end is hooked into the groove (613) in the long pin. The recliner mechanism actuating rod (611) is held in position along with recliner operating knob (70). Link (69), which is placed at the center of the long Pin (64) is connected to the link (67) with the help of pins (68). The link (69) is held on the long pin (64), with the help of split pin (615). The link (67) is held on the actuating rod (611) with the help of split pin (614). The back cover is provided with the projections (63) for fixing the flat cover, which also holds the pocket for instruction manual.

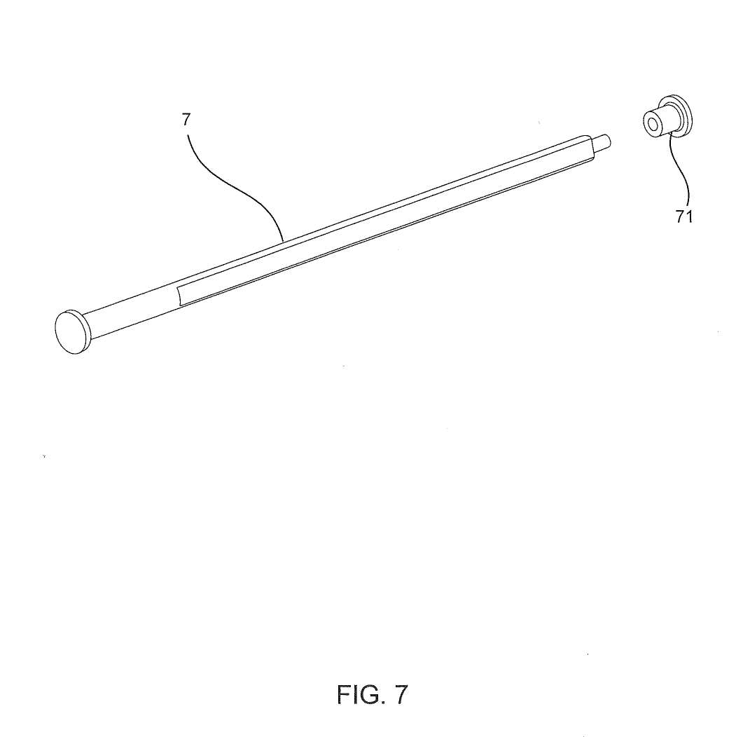

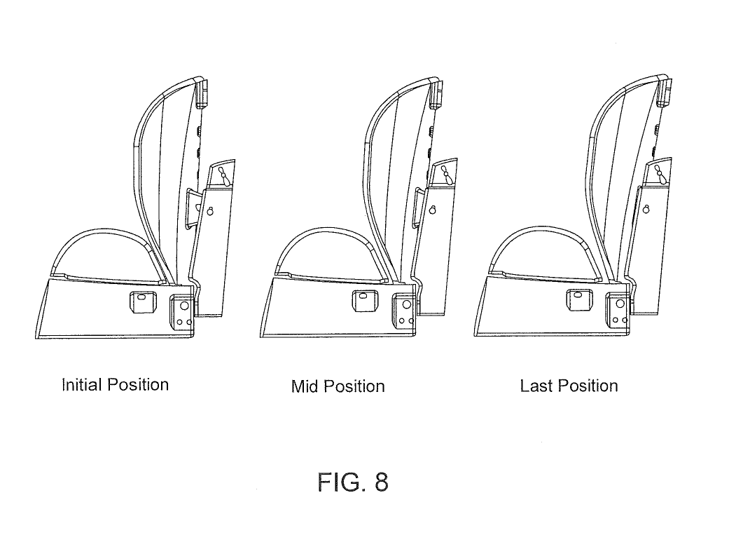

In accordance with the various embodiments of the present invention, FIG. 7 illustrates a D-shaped pin along (7) with a nut (59, 71). The seat back (1) is connected to the seat base cover (2) with the help of D-shaped pin. The D-shaped pin, which is held in the back cover, is supported by the slots provided in the seat back (1). This D-shaped pin is pushed through the hole (17) made in the round extension (12) of the child seat back. The rectangular flat face in the D-shaped pin is aligned with the matching rectangular face in the hole of round extension. This prevents the relative rotation of the seat back with the D-shaped pin and both move together. The D-shaped pin also passes through the base cover holes (64). D-shaped pin is supported at both ends in the base cover holes. Supporting area of these holes acts as bearing to the D-shaped pin. The D-shaped pin is threaded at one end, which is tightened with the nut against the back cover.

Functions, operations, components and/or features described herein with reference to one or more embodiments, may be combined with, or may be utilized in combination with, one or more functions, operations, components and/or features described herein with reference to one or more other embodiments, or vice versa.

While certain features of some embodiments of the invention have been illustrated and described herein, many modifications, substitutions, changes, and equivalents may occur to those skilled in the art. It is therefore, to be understood that the appended claims are intended to cover all such modifications and changes.

We claim:

1. A detachable seating device comprising:
an arrangement in a seat base to hold a seat back;
a mechanism to couple a seat base, the seat back and a seat back cover;
a mechanism of reclining the seat back housed in the seat back cover;
a mechanism for adjusting one or more reclining positions;
one or more detachable side support pads and hand rests; and
a mechanism housed in the seat base for detaching and replacing at least one detachable side support pad with at least one hand rest.

2. The detachable seating device as claimed in claim 1, wherein the arrangement in the seat base to hold the seat back comprises a D-shaped pin.

3. The detachable seating device as claimed in claim 2, wherein the mechanism to couple the seat base, the seat back and a seat back cover involves a circular extension at bottom end of the seat back.

4. The detachable seating device as claimed in claim 3, wherein the circular extension at the bottom end of the seat back is provided with a D-shaped hole and the D-shaped pin rotates along with the seat back, the seat back cover remaining fixed with a seat base cover acting as a bearing for the D-shaped pin.

5. The detachable seating device as claimed in claim 2, wherein the seat back and the seat base engaged together by a nut and a pin are capable of being disengaged by removal of the nut and the pin.

6. The detachable seating device as claimed in claim 1, wherein the mechanism of reclining the seat back housed in the seat back cover includes lifting at least one pin with at least two knobs on one or more sides.

7. The detachable seating device as claimed in claim 6, wherein at least one pin supported by one or more springs is under a spring force.

8. The detachable seating device as claimed in claim 6, wherein the mechanism of reclining the seat back involves a plurality of links, which are fixed to an actuating rod and at least one pin with one or more split pins.

9. The detachable seating device as claimed in claim 6, wherein at least two knobs on one or more sides of the actuating rod are involved in disengaging at least one pin from one or more slots for reclining.

10. The detachable seating device as claimed in claim 9, wherein one or more slots are provided in the seat back, an arrangement in the seat back cover engages with one or more slots for adjusting in at least one reclining position.

11. The detachable seating device as claimed in claim 1, wherein the mechanism for adjusting one or more reclining positions includes rotating at least two knobs.

12. The detachable seating device as claimed in claim 11, wherein rotating at least two knobs allows rotation of the actuating rod and with a plurality of connecting links it lifts at least one pin out of one or more slots in the seat back.

13. The detachable seating device as claimed in claim 12, wherein at least one pin is kept under pretention of one or more springs, an end of one or more springs being hooked to at least one pin and another end fixed to a projection in the seat back cover.

14. The detachable seating device as claimed in claim 1, wherein the mechanism for adjusting one or more reclining positions allows the seat back to recline in one or more orientations.

15. The detachable seating device as claimed in claim 14, wherein one or more reclining positions depends upon the positioning of at least one pin in one or more slots.

16. The detachable seating device as claimed in claim 1, wherein the mechanism housed in the seat base for detaching and replacing at least one detachable side support pad with at least one hand rest resides inside the seat base cover with one or more screws.

17. The detachable seating device as claimed in claim 16, wherein the mechanism housed in the seat base for detaching and replacing one or more detachable side support pad with at least one hand rest involves locking one or more notches on another rod locked with one or more slots in a slider.

18. The detachable seating device as claimed in claim 17, wherein the slider is held by the spring force and one or more springs are placed on a screw between the slider and a fixed end of a frame.
